(19) United States
(12) Patent Application Publication
(10) Pub. No.: US 2008/0035449 A1
(43) Pub. Date: Feb. 14, 2008

(54) SEMICONDUCTOR TRANSFER SYSTEM AND VEHICLE CONTROL METHOD THEREOF

(75) Inventor: Su Jeong LEE, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/750,018

(22) Filed: May 17, 2007

(30) Foreign Application Priority Data
Aug. 14, 2006 (KR) 2006-76823

(51) Int. Cl. B65G 47/46; G06F 7/00

(52) U.S. Cl. 198/349; 700/230

(57) ABSTRACT

A semiconductor transfer system, adopting a cell-integration rail-type article transfer structure, which is capable of systematically and effectively preventing the concentration or the shortage of the vehicles in specific sections, which may occur during the normal transfer of articles, and a vehicle control method thereof. The semiconductor transfer system is constructed in a cell-integration structure having a rail and a plurality of vehicles moving along the rail to transfer articles, in which the rail is divided into a plurality of sections, and a range of the number of vehicles moving in the respective sections is set. Whenever the number of vehicles deviates from the set range, unloaded vehicles are moved from the sections where the number of vehicles is greater than the set range to the relay section, or unloaded vehicles are moved from the relay section to the sections where the number of vehicles is less than the set range. Consequently, it is possible to effectively prevent the concentration or the shortage of the vehicles in specific sections.

### CROSS-REFERENCE TO RELATED APPLICATIONS

This application claims priority under 35 U.S.C. §119(a) from Korean Patent Application No. 2006-76823, filed on Aug. 14, 2006 in the Korean Intellectual Property Office, the entire disclosure of which is incorporated herein by reference.

### BACKGROUND OF THE INVENTION

1. Field of the Invention

The present general inventive concept relates to a semiconductor transfer system and a vehicle control method thereof, and more particularly to a method controlling a movement of vehicles used in a semiconductor transfer system to efficiently accomplish the transfer of articles in a semiconductor manufacturing line.

2. Description of the Related Art

A semiconductor is manufactured by sequentially performing unit processes, including film formation, pattern formation, and metal wire formation. For this reason, articles, including wafers or carriers having a plurality of wafers loaded thereon, are frequently transferred between the unit processes. Consequently, transfer systems to transfer the articles are constantly in development.

A conventional transfer system adopts a rail-type article transfer structure in which rails are disposed to provide article transfer routes in cells, each of which includes a plurality of arrangements to perform the unit processes, the rails are also disposed to provide additional article transfer routes between the cells, and vehicles move along the rails to transfer the articles.

An example of a semiconductor transfer system adopting a conventional rail-type article transfer structure is disclosed in Korean Patent No. 10-0350719.

In the conventional rail-type article transfer structure, the number of vehicles is restricted so that it is efficient during the transfer within respective cells. However, rails mounted between the respective cells are not connected with each other so that, during the transfer between the respective cells, processes to load and unload the articles must be performed in order of vehicles moving along the rail in a departure cell, vehicles moving along the rail disposed between the departure cell and an arrival cell, and vehicles moving along the rail in the arrival cell. This increases transfer time and requires additional arrangements to perform the processes.

Recently, therefore, a cell-integration rail-type article transfer structure has been used, in which a rail is constructed to interconnect all sections such that vehicles having articles loaded thereon can move directly from a departure area to an arrival area during transfer of articles between cells as well as during the transfer of the articles in the respective cells.

In the cell-integration rail-type article transfer structure, the vehicles having the articles loaded thereon move directly from the departure area to the arrival area, whereby a transfer time is reduced, and no additional arrangements to transfer the articles are needed.

In the cell-integration rail-type article transfer structure, however, the vehicles having articles loaded thereon move directly between the respective cells, and therefore, the vehicles may be concentrated in specific sections during the transfer of the articles, which causes a shortage of the vehicles in other sections. As a result, total semiconductor manufacturing efficiency is lowered.

In order to solve the above-mentioned problem, a method of moving unloaded vehicles from vehicle-concentrated sections to vehicles-deficient sections may be used. Even in this method, however, time necessary to move the vehicles is increased when a distance between the sections is large. Furthermore, this method is not an appropriate solution when distribution of vehicles in the respective sections is changed during movement of the vehicles.

### SUMMARY OF THE INVENTION

Therefore, it is an aspect of the present general inventive concept to provide a semiconductor transfer system, adopting a cell-integration rail-type article transfer structure, which is capable of systematically and effectively preventing the concentration or the shortage of the vehicles in specific sections, which may occur during the normal transfer of articles, thereby improving the transfer efficiency of the articles in a semiconductor manufacturing line, and a vehicle control method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a semiconductor transfer system including a rail to interconnect a plurality of sections, for which a range of the number of vehicles is set, to provide a route, along which the vehicles move in the sections or between the sections; and a vehicle controller to determine whether the number of vehicles is maintained in the set range in the sections during movement of the vehicle, and, when the number of vehicles deviates from the set range in at least one of the sections, to control the movement of the vehicles such that the number of vehicles is maintained in the set range in the at least one of the sections.

The vehicle controller may designate any one of the sections as a relay section, and the vehicle controller moves the vehicles between the at least one of the sections where the number of vehicles deviates from the set range and the relay section such that the number of vehicles is maintained in the set range in at least one of the sections where the number of vehicles deviates from the set range.

The sections may be arranged in a structure in which a first group including some of the sections arranged in parallel with each other is opposite to a second group including some of the sections arranged in parallel with each other, and one section is disposed between the first and second groups such that one section is adjacent to the first and second groups, and the vehicle controller designates the section disposed between the first and second groups as the relay section.

The vehicles may include one or more unloaded vehicles, and if the number of vehicles is greater than the set range in at least one of the sections, the vehicle controller moves unloaded vehicles in the at least one of the sections to the relay section.

The vehicles may include one or more unloaded vehicles, and if the number of vehicles is less than the set range in at least one of the sections, the vehicle controller moves unloaded vehicles in the relay section to the at least one of the sections.

The vehicle controller may determine the location of the unloaded vehicles moving in the relay section to move the unloaded vehicles to the sections where the number of vehicles is less than the set range in order of distance.

The rail may include a common rail disposed along the sections, a section rail disposed along the section and spaced apart from the common rail, and a connection rail to connect the section rail to the common rail to allow the vehicles to move between the section rail and the common rail.

The connection rail may also include a left track and a right track, and the vehicles move on one of the left track and the right track to move between the section rail and the common rail through the connection rail.

The vehicle may move from the section rail to the common rail through the connection rail.

The connection rail may also include a first connection rail connected between a first position of the section rail and the common rail and a second connection rail connected between a second position of the section rail and the common rail and the vehicle moves from the first position of the section rail to the common rail through the second position of the connection rail.

The connection rail may further include a plurality of tracks to connect the section rail to the common rail and the vehicles move on one of the plurality of tracks to move between the section rail and the common rail.

The section may further include cells having a plurality of manufacturing arrangements situated therein to perform unit processes for semiconductor manufacture.

A section rail may provide a unit for the vehicles to move between the cells that comprise the section and also between the manufacturing arrangements that comprise the cells.

The foregoing and/or other aspects of the present general inventive concept may also be achieved by providing a vehicle control method of a semiconductor transfer system, including moving a plurality of vehicles along a rail interconnecting a plurality of sections, for which a range of the number of vehicles is set, to provide a route, along which the vehicles move in the respective sections or between the respective sections, determining whether the number of vehicles is maintained within the set range in the respective sections, and if the number of vehicles deviates from the set range in at least one of the sections, moving the vehicles such that the number of vehicles is maintained in the set range in the at least one of the sections.

The method may further include determining whether the number of vehicles is maintained within the set range in the respective sections may also include designating any one of the sections as a relay section, and moving the vehicles such that the number of vehicles is maintained in the set range in the at least one of the sections includes moving the vehicles between the at least one of the sections where the number of vehicles deviates from the set range and the relay section such that the number of vehicles is maintained in the set range in the at least one of the sections.

The method may also include moving the vehicles such that the number of vehicles is maintained in the set range in the at least one of the sections may also include, if the number of vehicles is greater than the set range in the at least one of the sections, moving unloaded vehicles in the at least one of the sections to the relay section.

The method may also include moving the vehicles such that the number of vehicles is maintained in the set range in the at least one of the sections may include, if the number of vehicles is less than the set range in the at least one of the sections, moving unloaded vehicles in the relay section to the at least one of the sections.

The method may further include moving the vehicles such that the number of vehicles is maintained in the set range in the at least one of the sections may include determining the location of the unloaded vehicles moving in the relay section to move the unloaded vehicles to the sections where the number of vehicles is less than the set range in order of distance.

The method may further include moving the vehicle along the rail including a common rail disposed along the sections, a section rail disposed along the section and spaced apart from the common rail, and a connection rail to connect the section rail to the common rail to move between the section rail and the common rail.

The method may include moving the vehicle along the connection rail including a left track and a right track, and moving the vehicles on one of the left track and the right track to move between the section rail and the common rail through the connection rail.

The method may include moving the vehicle from the section rail to the common rail through the connection rail.

The method may further include moving the vehicle along the connection rail including a first connection rail connected between a first position of the section rail and the common rail and a second connection rail connected between a second position of the section rail and the common rail and the vehicle moves from the first position of the section rail to the common rail through the second position of the connection rail.

The method may further include moving the vehicle along a connection rail including a plurality of tracks to connect the section rail to the common rail and moving the vehicles on one of the plurality of tracks to move between the section rail and the common rail.

The method may further include the section including cells having a plurality of manufacturing arrangements situated therein to perform unit processes for semiconductor manufacture.

The method may also include moving a vehicle along a section rail that provides a unit for the vehicles to move between the cells that include the section and also between the manufacturing arrangements that comprise the cells.

The foregoing and/or other aspects of the present general inventive concept may also be achieved by providing a computer readable recording medium having embodied thereon a program which executes a vehicle control method of a semiconductor transfer system, the method may include moving a plurality of vehicles along a rail interconnecting a plurality of sections, for which a range of the number of vehicles is set, to provide a route, along which the vehicles move in the respective sections or between the respective sections, determining whether the number of vehicles is maintained within the set range in the respective sections; and if the number of vehicles deviates from the set range in at least one of the sections, moving the vehicles such that the number of vehicles is maintained in the set range in the at least one of the sections.

### BRIEF DESCRIPTION OF THE DRAWINGS

These and/or other aspects and advantages of the present general inventive concept will become apparent and more readily appreciated from the following description of the embodiments, taken in conjunction with the accompanying drawings, of which:

FIG. 1 is a view schematically illustrating a semiconductor transfer system according to an embodiment of the present general inventive concept;

FIG. 2 is a block diagram illustrating the semiconductor transfer system according to an embodiment of the present general inventive concept;

FIG. 3 is a flow chart illustrating a vehicle control method of a semiconductor transfer system according to an embodiment of the present general inventive concept; and

FIG. 4 is a view illustrating imaginary control sections of the semiconductor transfer system of FIG. 1, which are divided according to the vehicle control method of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below to explain the present general inventive concept by referring to the figures.

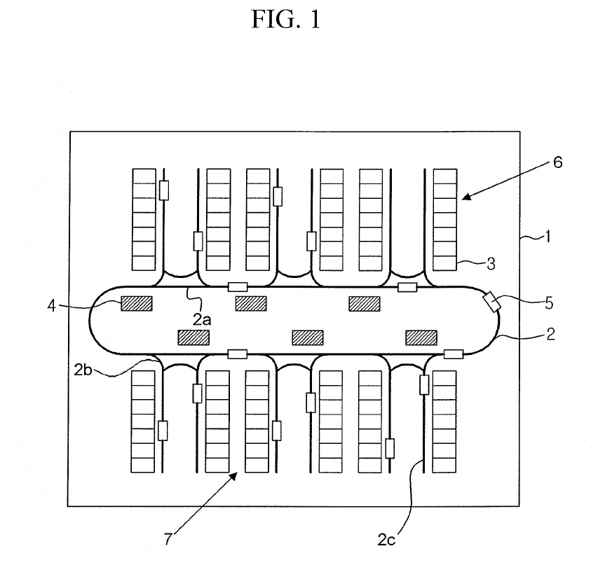

FIG. 1 is a view schematically illustrating a semiconductor transfer system adopting a cell-integration rail-type article transfer structure according to an embodiment of the present general inventive concept.

Manufacturing arrangements 3, which perform unit processes for semiconductor manufacture, and stockers 4, which temporarily store articles that have already been processed at the manufacturing arrangements 3 or are to be processed at the manufacturing arrangements 3, are appropriately disposed on a semiconductor manufacturing line 1 based on processing sequence and processing efficiency. The manufacturing arrangements 3 are situated within a cell 6. A section 7 is formed of plurality of cells 6.

A rail is mounted between the manufacturing arrangements 3 and the stockers 4 to provide an article transfer route necessary for semiconductor manufacture.

In the present embodiment, the rail 2 is constructed in a cell-integration structure in which the rail 2 is connected between sections 7 to provide a route to move within the respective sections 7 or between the sections 7. The rail 2 may include a common rail 2a disposed along the sections 7 and a section rail 2c disposed along a section and spaced apart from the common rail 2a to move the vehicles between the cells 6 of the respective sections 7. Each section 7 also has connection rails 2b to connect the section rail 2c to the common rail 2a. Even though the present embodiment illustrates a left connection rail and a right connection rail, the connection rails 2b may include a single connection rail or a plurality of connection rails in various positions. It is also possible to construct the rail 2 in other configurations depending upon the disposition, processing items, and in consideration of efficiency of the semiconductor manufacturing process.

A plurality of vehicles 5 are disposed on the rail 2 to transfer articles loaded from a departure area to designated ones of the manufacturing arrangements 3 or the stockers 4.

A method of controlling the vehicles includes an article loading mode and traveling mode. In the present embodiment, any one of the article loading mode and the traveling mode is adopted.

In the present embodiment, the vehicles 5 can move directly, along the rail 2, from one section 7 to another section 7 as well as within the respective sections 7. Consequently, additional arrangements necessary for the vehicles 5 to move between conventional cells may be omitted. If the vehicle is moving toward the common rail 2a, the vehicle 5 may take either the left or the right connection rail 2b disposed with respect to a center portion of the section rail 2c to move from the section rail 2c to the common rail 2a. However, other configurations of the connection rails 2b may allow for different movement of the vehicles 5. Once the vehicle 5 is on the common rail 2a, it may move either to the left or to the right depending on vehicle traffic and a destination of the vehicle 5.

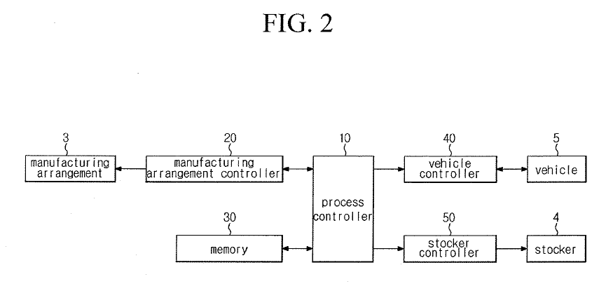

Hereinafter, construction and operation of the semiconductor transfer system according to the present embodiment will be described with reference to FIG. 2.

Referring to FIGS. 1 and 2, when a process controller 10, which controls a semiconductor manufacturing process, transmits a process start signal to manufacturing arrangement controllers 20, the manufacturing arrangement controllers 20 control the corresponding manufacturing arrangements 3 to be operated such that transferred articles are unloaded from the vehicles and corresponding processes are performed.

When the corresponding processes have been performed at the respective manufacturing arrangements 3, the manufacturing arrangement controllers 20 transmit a process end signal to the process controller 10. The process controller 10 transmits an article transfer signal, which is necessary to transfer processed articles to other manufacturing arrangements 3, to a vehicle controller 40 according to a processing sequence stored in a memory 30.

The vehicle controller 40 controls unloaded vehicles 5 to move to the manufacturing arrangements 3 where the processes have been completed according the signal transmitted from the process controller 10, and the corresponding manufacturing arrangement controllers 20 control the manufacturing arrangements 3 to be operated such that the processed articles are loaded to the vehicles 5.

The vehicle controller 40 transfers the articles loaded to the vehicles 5 to other manufacturing arrangements 3 according to a command, for example, a partial transfer signal, from the process controller 10. The manufacturing arrangement controllers 20 control the corresponding manufacturing arrangements 3, to which the articles have been transferred, to be operated according to a command, for example, a process start signal, from the process controller 10 such that the transferred articles are unloaded and corresponding processes are performed.

At this time, when the processed articles are to be transferred to the stockers 4 according to the processing sequence stored in the memory 30, the process controller 10 transmits a transfer signal, for example, the partial transfer signal, to the vehicle controllers 40, and transmits a processing signal to corresponding stocker controllers 50.

When the articles are transferred to the corresponding stockers 4 in the above-described fashion according to the command from the process controller 10, the stocker controllers 50 control arrangements provided at the stockers 4 to perform article unloading and storing processes according to the command from the process controller 10.

At this time, the vehicle controller 40 and the vehicles 5 exchange information with each other about current positions or designated positions using communication devices mounted therein. In the present embodiment, a conventional communication mode is adopted.

Meanwhile, a mode to transfer articles stored in the stockers 4 to the manufacturing arrangements 3 or other stockers 4 is identical to the above-described mode, and therefore, a detailed description thereof will be omitted.

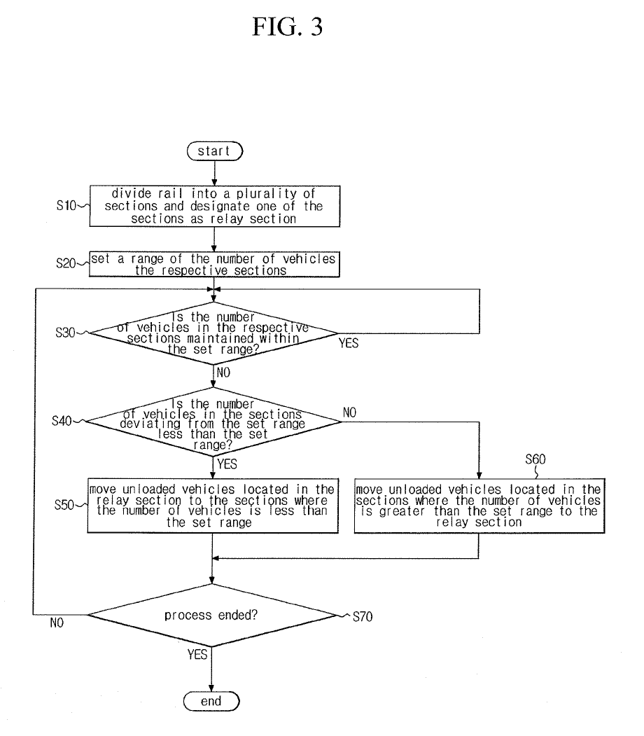

Hereinafter, a vehicle control method of a semiconductor transfer system according to an embodiment of the present general inventive concept will be described in detail with reference to FIG. 3.

Referring to FIGS. 1-3 an administrator of the semiconductor manufacturing line 1 divides the rail 2 disposed at the semiconductor manufacturing line 1 into a plurality of sections 7, and designates one of the sections 7 as a relay section (S10).

The sections 7 are imaginarily divided in a space so as to effectively operate and control the vehicles 5 moving through the respective sections 7 along the rail 2.

The relay section is used to control the number of vehicles in the respective sections 7. Consequently, it is preferable that the relay section be adjacent to other different sections 7.

After dividing the sections 7, the administrator sets a range of the number of vehicles for the respective sections (S20).

The number of vehicles means the number of vehicles 5 that must be maintained in the respective sections 7 during the whole transferring process should be in consideration of the amount of variation of the vehicles discharged to other sections 7 or introduced from other sections 7 through the article transferring process.

When articles are transferred within the respective sections 7, there are no introduction and discharge of the vehicles 5 between the respective sections 7. The result is that the number of the vehicles moving in the respective sections 7 is not changed. When articles are transferred between the respective sections 7, on the other hand, there are introduction and discharge of the vehicles 5 between the respective sections 7 with the result that the vehicles 5 may be concentrated in any one of the sections 7. In order to solve this problem, the range of the number of vehicles 5 in the respective sections 7 is set such that the number of vehicles can be maintained in the respective sections 7 within a predetermined range.

Consequently, it is preferable to set the range of the number of vehicles 5 in the respective sections 7, such that the articles can be transferred without hindrance of the total processing efficiency, in consideration of process time and process amount in the corresponding sections 7. When the semiconductor manufacturing process is changed, the range of the number of vehicles 5 in the respective sections 7 must be also changed.

When a semiconductor manufacturing process is initiated, after the sections 7 are divided and the range of the number of vehicles in the respective sections 7 is set, and the vehicles are moved to transfer articles, the vehicle controller 40 determines whether the number of vehicles 5 in the respective sections 7 is maintained within the set range (S30). When it is determined that the number of vehicles 5 is maintained within the set range, the procedure returns to S30, and the determination is continuously performed as to whether the number of vehicles 5 in the respective sections 7 is maintained within the set range.

When it is determined in S30 that the number of vehicles 5 is not maintained within the set range, the vehicle controller 40 determines whether the number of vehicles 5 in the sections 7 deviating from the set range is less than the set range (S40). When it is determined that the number of vehicles is less than the set range, the vehicle controller 40 controls the unloaded vehicles located in the relay section to move to the respective sections where the number of vehicles is less than the set range such that the number of vehicles 5 can be maintained within the set range in the corresponding sections (S50).

At this time, it is preferable that the vehicle controller 40 determines the location of the unloaded vehicles moving in the relay section such that the vehicles can move to the sections 7 where the number of vehicles is less than the set range in order of distance.

On the other hand, when it is determined in S40 that the number of vehicles 5 deviating from the set range is greater than the set range, the vehicle controller 40 controls unloaded vehicles located in the sections 7 where the number of vehicles is greater than the set range to move to the relay section such that the number of vehicles 5 can be maintained within the set range in the corresponding sections (S60).

When the number of vehicles distributed in the respective sections 7 is maintained within the set range of the respective sections 7, the vehicle controller 40 determines whether a process end signal has been transmitted to the vehicle controller 40 from the process controller 10. When the process end signal has been transmitted to the vehicle controller 40 from the process controller 10, the vehicle controller 40 ends the process. When the process end signal has not been transmitted to the vehicle controller 40 from the process controller 10, on the other hand, the procedure returns to S30, and the determination is continuously performed as to whether the number of vehicles 5 in the respective sections 7 is maintained within the set range (S70).

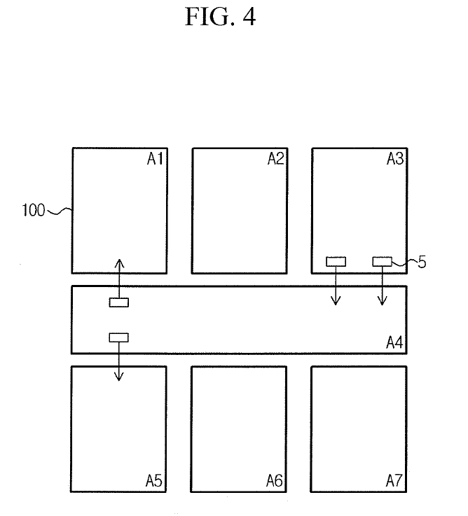

Hereinafter, an example of the vehicle control method of the semiconductor transfer system according to the present embodiment will be described with reference to FIG. 4.

FIG. 4 is a view illustrating imaginary control sections of the semiconductor transfer system of FIG. 1, which are divided according to the vehicle control method of FIG. 3. Referring to FIGS. 1-4, the rail 2 disposed at the semiconductor manufacturing line 1 is divided into seven imaginary control sections 100, and one of the imaginary control sections 100, i.e., A4 section, is designated as the relay section.

A first group including a first portion of the sections A1 to A3, which are arranged in parallel with each other, is opposite to a second group including a second portion of the sections A5 to A7, which are arranged in parallel with each other. The A4 section is disposed between the first and second groups such that the A4 section is adjacent to the first and second groups. Consequently, movement distance and movement time of the vehicles 5 moving to maintain the number of vehicles set for the respective sections 100 are minimized.

The following description will be given on the assumption that article-loaded vehicles 5 continuously move from the A1 and A5 sections to the A3 section, and, as a result, the number of vehicles 5 in the A1 and A5 sections is less than the set range by one each, and the number of vehicles 5 in the A3 section is greater than the set range by two.

In this case, the vehicle controller 40 moves two unloaded vehicles 5 from the A3 section 100 to the relay section, i.e., the A4 section 100. At the same time, the vehicle controller 40 moves two unloaded vehicles 5 from the A4 section to the A1 and A5 sections, respectively, i.e., one each. Consequently, the number of vehicles 5 in the respective sections is always maintained within the set range.

At this time, the vehicle controller 40 determines a location of the unloaded vehicles in the A4 section 100 to move one vehicle 5 nearest to the A1 section 100 and one vehicle 5 nearest to the A5 section 100 to the A1 and A5 sections, respectively.

According to the vehicle control method as described above, the movement of the vehicles 5 is accomplished through the relay section adjacent to the respective sections 7 such that the number of vehicles 5 is maintained within the set range in the respective sections where the number of vehicles 5 is less or greater than the set range. Consequently, even when the distance between sections 100 where the number of vehicles 5 is less than the set range and sections 100 where the number of vehicles 5 is greater than the set range is large, the variation of vehicles is accomplished for the respective sections 100 within a short time, and therefore, a concentration or a shortage of the vehicles 5 in specific sections is effectively prevented during the transfer of the articles.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As apparent from the above description, the present general inventive concept provides a semiconductor transfer system constructed in a cell-integration structure having a rail and a plurality of vehicles moving along the rail to transfer articles, in which the rail is divided into a plurality of sections, and a range of the number of vehicles moving in the respective sections is set. Whenever the number of vehicles deviates from the set range, unloaded vehicles are moved from the sections where the number of vehicles is greater than the set range to the relay section, or unloaded vehicles are moved from the relay section to the sections where the number of vehicles is less than the set range. Consequently, it is possible to effectively prevent the concentration or the shortage of the vehicles in specific sections.

Although a few embodiments of the present general inventive concept have been shown and described, it will be appreciated by those skilled in the art that changes may be made in these embodiments without departing from the principles and spirit of the present general inventive concept, the scope of which is defined in the appended claims and their equivalents.

What is claimed is:

1. A semiconductor transfer system comprising:
a rail to interconnect a plurality of sections, for which a range of the number of vehicles is set, to provide a route, along which the vehicles move in the respective sections or between the sections; and
a vehicle controller to determine whether the number of vehicles is maintained in the set range in the sections during movement of the vehicle, and, when the number of vehicles deviates from the set range in at least one of the sections, to control the movement of the vehicles such that the number of vehicles is maintained in the set range in the at least one of the sections.

2. The semiconductor transfer system according to claim 1, wherein the vehicle controller designates one of the sections as a relay section, and the vehicle controller moves the vehicles between the at least one of the sections where the number of vehicles deviates from the set range and the relay section such that the number of vehicles is maintained in the set range in the at least one of the sections where the number of vehicles deviates from the set range.

3. The semiconductor transfer system according to claim 2, wherein the sections are arranged in a structure in which a first group including a first portion of the sections arranged in parallel with each other is opposite to a second group including a second portion of the sections arranged in parallel with each other, and one section is disposed between the first and second groups such that the one section is adjacent to the first and second groups, and the vehicle controller designates the section disposed between the first and second groups as the relay section.

4. The semiconductor transfer system according to claim 2, wherein, the vehicles comprise one or more unloaded vehicles, and if the number of vehicles is greater than the set range in the at least one of the sections, the vehicle controller moves unloaded vehicles in the at least one of the sections to the relay section.

5. The semiconductor transfer system according to claim 2, wherein, the vehicles comprise one or more unloaded vehicles, and if the number of vehicles is less than the set range in at least one of the sections, the vehicle controller moves the unloaded vehicles in the relay section to the at least one of the sections.

6. The semiconductor transfer system according to claim 5, wherein the vehicle controller determines the location of the unloaded vehicles moving in the relay section to move the unloaded vehicles to the sections where the number of vehicles is less than the set range in order of distance.

7. The semiconductor transfer system according to claim 1, wherein the rail comprises:
a common rail disposed along the sections;
a section rail disposed along the section and spaced apart from the common rail; and
a connection rail to connect the section rail to the common rail to allow the vehicles to move between the section rail and the common rail.

8. The semiconductor transfer system according to claim 7, wherein the connection rail comprises a left track and a right track, and the vehicles move on one of the left track and the right track to move between the section rail and the common rail through the connection rail.

9. The semiconductor transfer system according to claim 7, wherein the connection rail comprises a plurality of tracks to connect the section rail to the common rail and the vehicles move on one of the plurality of tracks to move between the section rail and the common rail.

10. The semiconductor transfer system according to claim 1, wherein the section comprises cells having a plurality of manufacturing arrangements situated therein to perform unit processes for semiconductor manufacture.

11. The semiconductor transfer system according to claim 10, wherein a section rail provides a unit for the vehicles to move between the cells that comprise the section and also between the manufacturing arrangements that comprise the cells.

12. A vehicle control method of a semiconductor transfer system, comprising:
moving a plurality of vehicles along a rail interconnecting a plurality of sections, for which a range of the number of vehicles is set, to provide a route, along which the vehicles move in the respective sections or between the respective sections, determining whether the number of vehicles is maintained within the set range in the respective sections; and
if the number of vehicles deviates from the set range in at least one of the sections, moving the vehicles such that the number of vehicles is maintained in the set range in the at least one of the sections.

13. The vehicle control method according to claim 12, wherein
determining whether the number of vehicles is maintained within the set range in the respective sections includes designating any one of the sections as a relay section, and
moving the vehicles such that the number of vehicles is maintained in the set range in at least one of the sections includes moving the vehicles between the at least one of the sections where the number of vehicles deviates from the set range and the relay section such that the number of vehicles is maintained in the set range in the at least one of the sections.

14. The vehicle control method according to claim 13, wherein moving the vehicles such that the number of vehicles is maintained in the set range in the at least one of the sections includes, when the number of vehicles is greater than the set range in the at least one of the sections, moving unloaded vehicles in at least one of the sections to the relay section.

15. The vehicle control method according to claim 13, wherein moving the vehicles such that the number of vehicles is maintained in the set range in the at least one of the sections includes, when the number of vehicles is less than the set range in the at least one of the sections, moving unloaded vehicles in the relay section to at least one of the sections.

16. The vehicle control method according to claim 15, wherein moving the vehicles such that the number of vehicles is maintained in the set range in the at least one of the sections includes determining the location of the unloaded vehicles moving in the relay section to move the unloaded vehicles to the sections where the number of vehicles is less than the set range in order of distance.

17. The vehicle control method according to claim 12, wherein the method comprises moving the vehicle along the rail comprising:
moving the vehicles along a common rail disposed along the sections;
moving the vehicles along a section rail disposed along the section and spaced apart from the common rail; and
moving the vehicles along a connection rail to connect the section rail to the common rail to move between the section rail and the common rail.

18. The vehicle control method according to claim 17, wherein the connection rail comprises a left track and a right track, and moving of the vehicles comprises moving the vehicles on one of the left track and the right track to move between the section rail and the common rail through the connection rail.

19. The vehicle control method according to claim 17, wherein the method comprises moving the vehicle along a connection rail comprising a plurality of tracks to connect the section rail to the common rail and moving the vehicles on one of the plurality of tracks to move between the section rail and the common rail.

20. The vehicle control method according to claim 12, wherein the section comprises cells having a plurality of manufacturing arrangements situated therein to perform unit processes for semiconductor manufacture.

21. The vehicle control method according to claim 20, wherein moving the vehicles comprises moving a vehicle along a section rail that provides a unit for the vehicles to move between the cells that comprise the section and also between the manufacturing arrangements that comprise the cells.
